(19) United States
(12) Patent Application Publication
(10) Pub. No.: US 2009/0220742 A1
(43) Pub. Date: Sep. 3, 2009

(54) BRIGHTNESS ENHANCEMENT REFLECTIVE FILM

(75) Inventors: Yi-Chia Wang, (US); Sue-Hong Liu, Kaohsiung (TW)

Correspondence Address: LADAS & PARRY LLP, 26 WEST 61ST STREET, NEW YORK, NY, 10023, US

(73) Assignee: ETERNAL CHEMICAL CO., LTD.,

(21) Appl. No.: 12/392,262

(22) Filed: Feb. 25, 2009

(30) Foreign Application Priority Data
Feb. 29, 2008 (TW) 097107230

(51) Int. Cl. B32B 5/16

(52) U.S. Cl. 428/147; 428/143

(57) ABSTRACT

The subject invention provides a reflective film comprising a reflective substrate and a resin coating having a convex-concave structure on a surface of the substrate, wherein said resin coating comprises organic particles and a binder, the particle size distribution of the organic particles ranges within about ±5% of the mean particle size of the organic particles, and the organic particles are in an amount from about 180 to about 320 parts by weight per 100 parts by weight of the solid contents of the binder.

### BACKGROUND OF THE INVENTION

1. Field of the Invention

The present invention relates to a reflective film. In particular, the present invention relates to a reflective film applicable to a backlight module.

2. Description of the Prior Art

Liquid crystal display (LCD) has the advantages of high definition, low radiation, low energy consumption, better space utilization, etc., and has replaced cathode-ray tube (CRT) gradually and become mainstream in the market. Since a liquid crystal display cannot emit light by itself, it is necessary to use a backlight module as a light source so that the display device can display images normally.

The main elements of a backlight module include an incident light source, a reflective film, a lightguide plate, a diffusion plate, a diffusion film, a brightness enhancement film and a prism-protecting film. Depending on the structures, backlight modules are normally classified into two types, i.e., direct type and side type backlight modules. Direct type backlight modules have a light source disposed right below a diffusion plate and are generally utilized in a display device of a relatively large size, for example, TV sets. As for the side type backlight modules, the light source is disposed at the sides of the lightguide plate, so that the light source emits light after being guided in a correct direction by the lightguide plate. Generally, the side type backlight modules are used in a display device of a relatively small size, for example, notebook computers and monitors.

The main function of the reflective film is to reflect scattered light to the lightguide plate or the diffusion plate so as to enhance light efficiency. In general, in direct type backlight modules, the reflective film is disposed on or adhered to the surface of the bottom of the light box so that the reflective light from the diffusion plate can be reflected by the reflective film back to the diffusion plate and can be further utilized. In side type backlight modules, the reflective film is disposed below the lightguide plate and reflects the light, which passes through the lightguide plate but is not directly transmitted upward, back to the lightguide plate, so that the light loss is reduced and the light utilization is improved.

In general, reflective films are made from a white plastic material, such as polycarbonate (PC) or polyethylene terephthalate (PET), and the reflection coefficient of the reflective films can be increased by adding inorganic fillers, such as titanium dioxide (TiO₂) or barium sulfate (BaSO₄) particles. However, inorganic fillers, such as titanium dioxide particles, absorb light in a specific wavelength range, so the reflection coefficient will be decreased in that specific wavelength range. Hence, U.S. Pat. No. 5,672,409 discloses the use of a white polyester film having fine voids as a reflective film to reduce such light absorption and increase the reflection coefficient of the reflective film.

In order to enhance the optical performance of the backlight modules without adversely affecting the brightness and light uniformity properties, there have been many modifications of the structure of the reflective films, for example, those disclosed in TW 593926 and TW I232335. In addition, U.S. Pat. No. 6,906,761 B2 discloses a reflective film which is formed by overlaying a scratch resistant layer having surface roughness on a white synthetic resin substrate. The scratch resistant layer comprises a binder and beads made of a flexible material dispersed in said binder. U.S. Pat. No. 6,906,761 B2 provides a reflection property by the utilization of a white synthetic resin substrate, reduces the scratch on the reflective film caused by other films (such as a lightguide plate) by the utilization of a scratch resistant layer coated with beads that are made of a flexible material, and further improves the brightness and light uniformity of the reflective film.

In order to enhance light utilization, U.S. Pat. No. 6,943,855 B2 discloses applying a coating comprising a white pigment (which basically comprises titanium oxide) onto the back side of a synthetic resin substrate to form a highly concealing layer having luminosity of greater than 95, thereby improving the reflection property and the concealing property of the reflective film and reducing the light loss from the back side of the reflective film. U.S. Pat. No. 6,943,855 B2 further teaches forming a diffusion layer comprising a binder and diffusive particles on the other side of the substrate so as to diffuse light and enhance the concealing property of the reflective film. However, U.S. Pat. No. 6,943,855 B2 does not disclose any method that can effectively homogenize the light reflected by the reflective film. As shown in FIG. 2 of U.S. Pat. No. 6,943,855 B2, the diffusive particles are randomly dispersed in the diffusion layer and the diffusive particles may overlap each other. The overlapping phenomenon of the diffusive particles may affect the uniformity of the light from the reflective film; besides, as the light path is increased, the light loss during the path is likely to be increased. In addition, since the particle size distribution of the diffusive particles of U.S. Pat. No. 6,943,855 B2 is wide, the light will be scattered randomly and cannot be efficiently utilized.

Given the above, how to enhance the optical performance of the reflective film, reduce the light loss and re-utilize available light has become an issue that has received a lot of attention in the filed. However, when a reflective film is used to reduce the waste of light and enhance the brightness of the backlight module, how to effectively control the distribution of light field of the reflected light so as to achieve good uniformity of reflected light and greatly enhance the front brightness or luminance is also an issue that should be addressed.

### SUMMARY OF THE INVENTION

Hence, the main objective of the present invention is to provide a reflective film, which can effectively reduce the light loss and control the distribution of light field of the reflected light, thereby enhancing the brightness and uniformity of the backlight module.

To achieve the above and other objectives, the present invention provides a reflective film comprising a reflective substrate and a resin coating having a convex-concave structure on a surface of the substrate, wherein said resin coating comprises organic particles and a binder, the particle size distribution of the organic particles ranges within about ±5% of the mean particle size of the organic particles, and the organic particles are in an amount from about 180 to about 320 parts by weight per 100 parts by weight of the solid contents of the binder.

### BRIEF DESCRIPTION OF THE DRAWINGS

FIGS. 1-4 illustrate the embodiments of the reflective film of the present invention.

### DETAILED DESCRIPTION OF THE INVENTION

The reflective film of the present invention is illustrated below in detail by the embodiments with reference to the drawings, which are not intended to limit the scope of the present invention. It will be apparent that any modifications or alterations that can be easily accomplished by those having ordinary skill in the art fall within the scope of the disclosure of the specification.

The reflective substrate of the present invention can be any substrate known to persons having ordinary skill in the art, such as glass or plastic. The plastic substrate is composed of at least one polymeric resin layer. The species of the polymeric resinare not particularly limited, and include, for example, but are not limited to, polyester resins, such as polyethylene terephthalate (PET) and polyethylene naphthalate (PEN); polyacrylate resins, such as polymethyl methacrylate (PMMA); polyimide resins; polyolefin resins, such as polyethylene (PE) and polypropylene (PP); polycycloolefin resins; polycarbonate resins; polyurethane resins; triacetate cellulose (TAC); polylactic acid; or a mixture thereof. The preferred substrates are those formed from polyethylene terephthalate, polymethyl methacrylate, polycycloolefin resin, triacetate cellulose, polylactic acid, or a mixture thereof. More preferably, the substrate is formed from polyethylene terephthalate. The thickness of the substrate typically depends on the requirement of the desired optical product, and is preferably in a range of from about 16 μm to about 1,000 μm.

The reflective substrate of the present invention can be a monolayer or multilayer structure, wherein one or more layers of said monolayer or multilayer structure can optionally contain bubbles and/or fillers. The fillers can be organic fillers or inorganic fillers. The species of the organic fillers include, for example, but are not limited to, an acrylic resin, a methacrylic resin, a urethane resin, a silicone resin, or a mixture thereof. The species of the inorganic fillers include, for example, but are not limited to, zinc oxide, silica, titanium dioxide, alumina, calcium sulfate, barium sulfate, calcium carbonate, or a mixture thereof, among which barium sulfate, titanium dioxide, calcium sulfate, or a mixture thereof are preferred. The diameter of the fillers or bubbles is in a range of from about 0.01 μm to about 10 μm, preferably from 0.1 μm to 5 μm. According to a preferred embodiment of the present invention, the substrate of the present invention can be a multilayer structure, wherein one or more layers of said multilayer structure contain fillers. According to a more preferred embodiment, the present invention uses a plastic substrate with a structure composed of three polymeric resin layers, wherein the intermediate layer of the tri-layered structure contains inorganic fillers.

The reflective substrate of the present invention can be composed of commercially available films. The commercially available films applicable to the present invention include, for example, but are not limited to, the films under the trade names uxz1-188®, uxz1-225®, ux-150®, ux-188® and ux-225®, produced by Teijin-Dupont Company; the films under the trade names E60L®, QG08®, QG21®, QX08® and E6SL®, produced by Toray Company; the films under the trade names WS22OE® and WS180E®, produced by Mitsui Company; the film under the trade name RF230®, produced by Tsujiden Company; and the films under the trade names FEB200®, FEB250®, and FEB300®, produced by Yupo Company.

In order to effectively control the light field distribution of the reflected light so as to render the reflected light more uniform and enhance the brightness, in the present invention, a resin coating having a micro convex-concave structure is coated on the substrate to provide light diffusing and light-gathering effects. The resin coating comprises organic particles and a binder, wherein the organic particles are in an amount from about 180 to about 320 parts by weight per 100 parts by weight of the solid contents of the binder, preferably in an amount from about 220 to about 305 parts by weight per 100 parts by weight of the solid contents of the binder.

According to the present invention, the shape of the organic particles is not particularly limited, and can be, for example, spherical or elliptic or irregular shape, of which the spherical shape is preferred. The organic particles have a mean particle size ranging from about 5 μm to about 30 μm, preferably from about 10 μm to about 25 μm. More preferably, the organic particles have a mean particle size of about 10, 15, or 20 μm. The organic particles provide a light scattering effect. In order to enhance the brightness of the light reflected from the reflective substrate to the diffusion plate or lightguide plate, and to effectively control the light field distribution thereof, the organic particles used in the present invention have a highly uniform particle size distribution, i.e., the particle size distribution of the organic particles ranges within about ±5%, preferably within about ±4%, of the mean particle size of the particles. For example, according to the present invention, if the organic particles have a mean particle size of about 15 μm, the particle size distribution of the organic particles in the resin coating will range from 14.25 μm to 15.75 μm, preferably from 14.4 μm to 15.6 μm. The particle size distribution of the organic particles of the present invention is relatively narrow, so the present invention can avoid wastes of the light source caused by an excessively broad light scattering range due to the significant difference in the particle size of the organic particles, thereby enhancing the luminance of the reflective film.

According to the present invention, the organic particles are uniformly distributed in the resin coating in a single layer. In comparison with the overlapping distribution of particles adopted in known technologies, the single-layer uniform distribution can not only reduce the raw material cost, but also reduce the wastes of the light source, thereby enhancing the brightness of the backlight module. According to the present invention, the organic particles are distributed in the resin coating in a single layer, wherein the film thickness is measured so as to make sure that there is only one particle at a same position, and the overlapping phenomenon of two particles at a same position can be avoided. Furthermore, in order to optimize the diffusion and light-gathering effect, the coating thickness of the binder is approximately from two fifths to three fifths of the particle size of the organic particles, and is preferably approximately a half of the particle size of the organic particles (i.e., the hemispheric height).

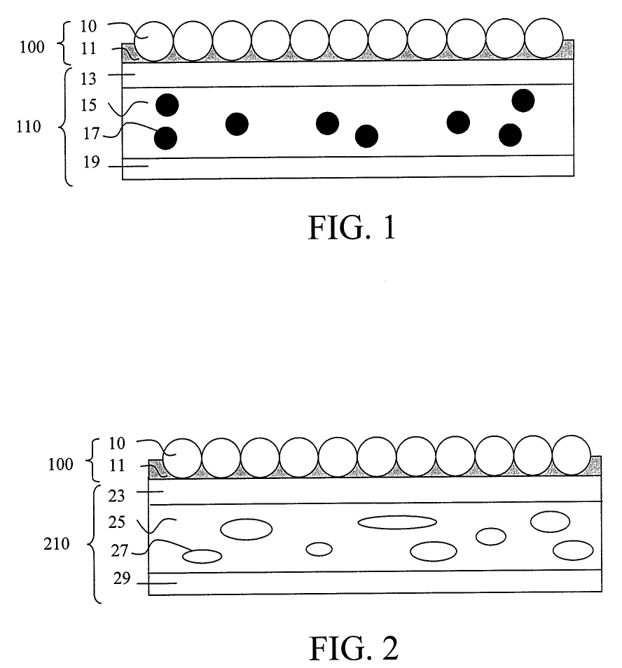

FIGS. 1 to 4 illustrate the embodiments of the reflective film according to the present invention. As shown in FIGS. 1 to 4, the reflective film of the present invention is obtained by forming a resin coating 100 having a convex-concave structure on a surface of the reflective substrate 110, 210, 310 or 410. The resin coating 100 includes organic particles 10 and a binder 11. In order to obtain an excellent light diffusion effect, as disclosed hereinbefore, the coating thickness of the binder is preferably approximately from two fifths to three fifths of the particle size of the organic particles, and is more preferably approximately a half of the particle size of the organic particles (i.e., the hemispheric height). In order to enhance the brightness of the reflected light and effectively control the light field distribution thereof, as disclosed hereinbefore, the particle size distribution of the organic particles used in the present invention ranges within about ±5%, preferably ranges within about ±4%, of the mean particle size of the particles, and preferably, the organic particles are uniformly distributed in the resin coating in a single layer.

FIG. 1 shows a preferred embodiment of the reflective film of the subject invention, wherein a resin coating 100 having a convex-concave structure is coated on one surface of the reflective substrate 110. As shown in FIG. 1, the resin coating 100 includes organic particles 10 and a binder 11; the reflective substrate 110 is composed of a first substrate layer 13, a second substrate layer 15, and a third substrate layer 19, wherein the second substrate layer 15 contains inorganic fillers 17. The species of the substrate can be any of those defined hereinbefore. For example, the substrate can be a PET resin one, which can be, for example, the commercially available film under the trade name ux-225®, which contains barium sulfate as inorganic fillers in the second substrate layer 15.

FIG. 2 shows another preferred embodiment of the reflective film of the present invention, wherein a resin coating 100 having a convex-concave structure is coated on the reflective substrate 210. As shown in FIG. 2, the resin coating 100 includes organic particles 10 and a binder 11; the reflective substrate 210 is composed of a first substrate layer 23, a second substrate layer 25, and a third substrate layer 29, wherein the second substrate layer 25 contains bubbles 27. The species of the substrate can be any of those defined hereinbefore. For example, the substrate is a PET resin one, which can be for example, a commercially available film under the trade name E6SL®, of which the second substrate layer 25 contains bubbles.

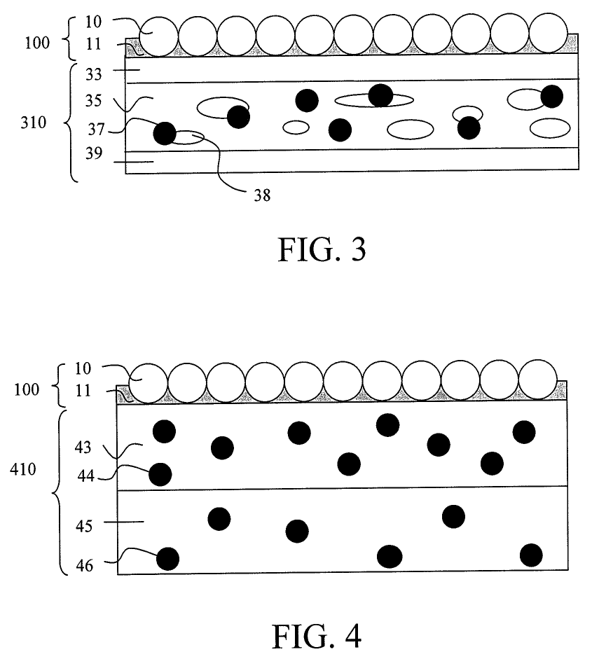

FIG. 3 shows yet another embodiment of the reflective film of the present invention, wherein a resin coating 100 having a convex-concave structure is coated on the reflective substrate 310. As shown in FIG. 3, the resin coating 100 includes organic particles 10 and a binder 11; the reflective substrate 310 is composed of a first substrate layer 33, a second substrate layer 35, and a third substrate layer 39, wherein the second substrate layer 35 contains both inorganic fillers 37 and bubbles 38. The species of the substrate can be any of those defined hereinbefore. For example, the substrate is a PP resin one, which can be for example, a commercially available film under the trade name RF230®, of which the second substrate layer 35 contains, in addition to bubbles, titanium dioxide and calcium carbonate as inorganic fillers.

FIG. 4 shows yet one more another embodiment of the reflective film of the present invention, wherein a resin coating 100 having a convex-concave structure is coated on the reflective substrate 410. As shown in FIG. 4, the resin coating 100 includes organic particles 10 and a binder 11; the reflective substrate 410 is composed of a first substrate layer 43 and a second substrate layer 45, wherein the first substrate layer 43 contains more inorganic fillers 44 and the second substrate layer 45 contains less inorganic fillers 46. The species of the substrate can be those defined as hereinbefore. For example, the substrate is a PET resin or PEN resin substrate or a combination thereof. A specific example is a commercially available film under the trade name uxz1-225®, which is composed of PET resin and PEN resin and contains barium sulfate as inorganic fillers.

The species of the organic particles 10 used in the resin coating 100 of the present invention are not particularly limited, and can be, for example, those of a polyacrylate resin, polystyrene resin, polyurethane resin, polysilicone resin, or a mixture thereof, among which the polyacrylate resin is preferred. The polyacrylate resin may comprise at least one mono-functional acrylate monomer and at least one multi-functional acrylate monomer as the polymerization units, and all the multi-functional acrylate monomers are in an amount from about 30% to 70% based on the total weight of the monomers. According to the present invention, at least one multi-functional monomer is used, such that the monomers undergo crosslinking reaction with each other, and the crosslinking degree of the obtained organic particles can be enhanced. Therefore, the hardness of the organic particles is enhanced so as to enhance the scratch resistance and wear resistance properties of the organic particles, and improve the solvent resistance of the particles to the binder.

The mono-functional acrylate monomer suitable for the present invention is selected from, but not limited to, the group consisting of methyl methacrylate (MMA), butyl methacrylate, 2-phenoxy ethyl acrylate, ethoxylated 2-phenoxy ethyl acrylate, 2-(2-ethoxyethoxy)ethyl acrylate, cyclic trimethylolpropane formal acrylate, β-carboxyethyl acrylate, lauryl methacrylate, isooctyl acrylate, stearyl methacrylate, isodecyl acrylate, isobornyl methacrylate, benzyl acrylate, 2-hydroxyethyl methacrylate phosphate, hydroxyethyl acrylate (HEA), 2-hydroxyethyl methacrylate (HEMA), and a mixture thereof.

The multi-functional acrylate monomer suitable for the present invention is selected from, but not limited to, the group consisting of hydroxypivalyl hydroxypivalate diacrylate, ethoxylated 1,6-hexanediol diacrylate, dipropylene glycol diacrylate, tricyclodecane dimethanol diacrylate, ethoxylated dipropylene glycol diacrylate, neopentyl glycol diacrylate, propoxylated neopentyl glycol diacrylate, ethoxylated bisphenol-A dimethacrylate, 2-methyl-1,3-propanediol diacrylate, ethoxylated 2-methyl-1,3-propanediol diacrylate, 2-butyl-2-ethyl-1,3-propanediol diacrylate, ethylene glycol dimethacrylate (EGDMA), diethylene glycol dimethacrylate, tris(2-hydroxy ethyl)isocyanurate triacrylate, pentaerythritol triacrylate, ethoxylated trimethylolpropane triacrylate, propoxylated trimethylolpropane triacrylate, trimethylolpropane trimethacrylate, pentaerythritol tetraacrylate, ethoxylated pentaerythritol tetraacrylate, ditrimethylolpropane tetraacrylate, propoxylated pentaerythritol tetraacrylate, pentaerythritol tetraacrylate, dipentaerythritol hexaacrylate, tripropylene glycol dimethacrylate, 1,4-butanediol dimethacrylate, 1,6-hexanediol dimethacrylate, allylated cyclohexyl dimethacrylate, isocyanurate dimethacrylate, ethoxylated trimethylol propane trimethacrylate, propoxylated glycerol trimethacrylate, trimethylol propane trimethacrylate, tris(acryloxyethyl)isocyanurate, and a mixture thereof.

According to a preferred embodiment of the present invention, the organic particles 10 contained in the resin coating 100 are polyacrylate resin particles formed from the monomers containing methyl methacrylate and ethylene glycol dimethacrylate, where the weight ratio of the methyl methacrylate monomer to the ethylene glycol dimethacrylate monomer can be 70:30, 60:40, 50:50, 40:60 or 30:70. When the amount of the ethylene glycol dimethacrylate monomer is about 30 wt % to about 70 wt % based on the total weight of the monomers, a better crosslinking degree can be obtained.

The binder 11 contained in the resin coating 100 is preferably colorless and transparent so as to allow the light to pass there through. The binder 11 can be selected from the group consisting of a ultraviolet (UV) curing resin, a thermal setting resin, a thermal plastic resin, and a mixture thereof, which is optionally processed by heat curing, UV curing, or heat and UV dual curing, so as to form the resin coating of the present invention. In an embodiment of the present invention, in order to enhance the hardness of the coating and prevent the film from warping, the binder 11 contains a UV curing resin and a resin selected from the group consisting of a thermal setting resin, a thermal plastic resin and a mixture thereof, and is treated by heat and UV dual curing, so as to form a resin coating with excellent heat-resistant property and extremely low volume shrinkage.

The UV curing resin useful in the present invention is formed from at least one acrylic or acrylate monomer having one or more functional groups, of which the acrylate monomer is preferred. The acrylate monomer suitable for the present invention includes, but is not limited to, a methacrylate monomer, an arcrylate monomer, a urethane acrylate monomer, a polyester acrylate monomer, or an epoxy acrylate monomer, and preferably an arcrylate monomer.

For example, the acrylate monomer suitable for the UV curing resin used in the present invention is selected from the group consisting of methyl methacrylate, butyl acrylate, 2-phenoxy ethyl acrylate, ethoxylated 2-phenoxy ethyl acrylate, 2-(2-ethoxyethoxy)ethyl acrylate, cyclic trimethylolpropane formal acrylate, β-carboxyethyl acrylate, lauryl methacrylate, isooctyl acrylate, stearyl methacrylate, isodecyl acrylate, isobornyl methacrylate, benzyl acrylate, hydroxypivalyl hydroxypivalate diacrylate, ethoxylated 1,6-hexanediol diacrylate, dipropylene glycol diacrylate, tricyclodecane dimethanol diacrylate, ethoxylated dipropylene glycol diacrylate, neopentyl glycol diacrylate, propoxylated neopentyl glycol diacrylate, ethoxylated bisphenol-A dimethacrylate, 2-methyl-1,3-propanediol diacrylate, ethoxylated 2-methyl-1,3-propanediol diacrylate, 2-butyl-2-ethyl-1,3-propanediol diacrylate, ethylene glycol dimethacrylate, diethylene glycol dimethacrylate, 2-hydroxyethyl methacrylate phosphate, tris(2-hydroxy ethyl)isocyanurate triacrylate, pentaerythritol triacrylate, ethoxylated trimethylolpropane triacrylate, propoxylated trimethylolpropane triacrylate, trimethylolpropane trimethacrylate, pentaerythritol tetraacrylate, ethoxylated pentaerythritol tetraacrylate, ditrimethylolpropane tetraacrylate, propoxylated pentaerythritol tetraacrylate, pentaerythritol tetraacrylate, dipentaerythritol hexaacrylate, hydroxyethyl acrylate (HEA), 2-hydroxyethyl methacrylate (HEMA), tripropylene glycol dimethacrylate, 1,4-butanediol dimethacrylate, 1,6-hexanediol dimethacrylate, allylated cyclohexyl dimethacrylate, isocyanurate dimethacrylate, ethoxylated trimethylol propane trimethacrylate, propoxylated glycerol trimethacrylate, trimethylol propane trimethacrylate, tris(acryloxyethyl) isocyanurate, and a mixture thereof. Preferably, the acrylate monomers contain dipentaerythritol hexaacrylate, trimethylolpropane triacrylate, and pentaerythritol triacrylate.

In order to improve the film-forming property of the resin coating, the UV curing resin used in the present invention may optionally contain an oligomer having a molecular weight in a range from 10³ to 10⁴. Such oligomers are well known to persons having ordinary skill in the art, such as, acrylate oligomers, which include, for example, but are not limited to, urethane acrylates, such as aliphatic urethane acrylates, aliphatic urethane hexaacrylates, and aromatic urethane hexaacrylates; epoxy acrylates, such as bisphenol-A epoxy diacrylate and novolac epoxy acrylate; polyester acrylates, such as polyester diacrylate; or homo-acrylates.

The thermal setting resin suitable for the present invention typically has an average molecular weight in a range from 10⁴ to 2×10⁶, preferably from 2×10⁴ to 3×10⁵, and more preferably from 4×10⁴ to 10⁵. The thermal setting resin of the present invention can be selected from the group consisting of a hydroxyl (—OH) and/or carboxyl (—COOH) group-containing polyester resin, epoxy resin, polymethacrylate resin, polyacrylate resin, polyamide resin, fluoro resin, polyimide resin, polyurethane resin, alkyd resin, and a mixture thereof, of which the polymethacrylate resin or polyacrylate resin containing a hydroxyl (—OH) and/or carboxy (—COOH) group is preferred, such as a polymethacrylic polyol resin.

The thermal plastic resin that can be used in the present invention is selected from the group consisting of polyester resins; polymethacrylate resins, such as polymethyl methacrylate (PMMA); and a mixture thereof.

The thickness of the resin coating of the optical film of the present invention normally depends on the requirements of the desired product, and is typically in the range from about 5 μm to about 30 μm, preferably in the range from about 10 μm to about 25 μm.

In addition to the organic particles and the binder, the resin coating of the present invention may optionally contain any additives known to persons having ordinary skill in the art, which include, but are not limited to, an anti-static agent, a curing agent, a photo initiator, a fluorescent whitening agent, a UV absorber, a leveling agent, a wetting agent, a stabilizing agent, a dispersing agent, or inorganic particulates.

The anti-static agent suitable for the present invention is not particularly limited, and can be any anti-static agent well known to persons having ordinary skill in the art, such as ethoxy glycerin fatty acid esters, quaternary amine compounds, aliphatic amine derivatives, epoxy resins (such as polyethylene oxide), siloxane, or other alcohol derivatives, such as poly(ethylene glycol) ester, poly(ethylene glycol) ether and the like.

The curing agent suitable for the present invention can be any curing agent well known to persons having ordinary skill in the art and capable of making the molecules to be chemically bonded with each other to form crosslinking, and can be, for example, but is not limited to, diisocynate or polyisocyanate. When the resin coating of the present invention contains a curing agent, the organic particles of the present invention may optionally be prepared from the monomers containing a hydroxyl group (—OH), a carboxy group (—COOH), or an amino group (—NH₂), preferably a hydroxyl group, such that the organic particles can contain surface functional groups and can directly react with the curing agent in the resin coating, so as to improve the adhesion, reduce the amount of the binder and enhance the luminance of the optical film. Examples of the monomers containing a hydroxyl group include, but are not limited to, hydroxyethyl acrylate (HEA), hydroxypropyl acrylate (HPA), 2-hydroxyethyl methacrylate (HEMA), and hydroxypropyl methacrylate (HPMA), and a mixture thereof.

The photo initiator used in the present invention will generate free radicals after being irradiated, and initiate a polymerization through delivering the free radicals. The photo initiator applicable to the present invention is not particularly limited, which includes, for example, but is not limited to, benzophenone, benzoin, 2-hydroxy-2-methyl-1-phenyl-propan-1-one, 2,2-dimethoxy-1,2-diphenylethan-1-one, 1-hydroxy cyclohexyl phenyl ketone, 2,4,6-trimethylbenzoyl diphenyl phosphine oxide, and a mixture thereof. Preferably, the photo initiator is benzophenone or 1-hydroxy cyclohexyl phenyl ketone.

The fluorescent whitening agent suitable for the present invention is not particularly limited, and can be any fluorescent whitening agent well known to persons having ordinary skill in the art, which can be an organic, including, for example, but being not limited to, a benzoxazole, a benzimidazole, or a diphenylethylene bistriazine; or an inorganic, including, for example, but being not limited to, zinc sulfide.

The UV absorber suitable for the present invention can be any UV absorber well known to persons having ordinary skill in the art, for example, a benzotriazole, a benzotriazine, a benzophenone, or a salicylic acid derivative.

Moreover, in order to prevent the reflective substrate from yellowing, inorganic particulates capable of absorbing UV light can be optionally added to the resin coating. The inorganic particulates can be, for example, but are not limited to, zinc oxide, zirconia, alumina, strontium titanate, titanium dioxide, calcium sulfate, barium sulfate, calcium carbonate, or a mixture thereof, of which titanium dioxide, zirconia, alumina, zinc oxide, or a mixture thereof is preferred. The particle size of the above-mentioned inorganic particulates is typically in the range from about 1 nanometer (nm) to about 100 nm, preferably from about 20 nm to about 50 nm.

The reflective film of the present invention provides a reflection coefficient of 96% or more in a wavelength range of visible light between 400 nm and 780 nm. According to ASTM D523 standard method, when the light source projects with an incident angle of 60°, the gloss of the reflective film of the present invention measured at the 60° reflective angle is lower than 10%, such that the reflective film of the present invention can effectively utilize light, produce a similar Lambertian reflection and achieve a diffusion-reflection effect. In addition, the reflective film of the present invention has excellent weatherability, and since the reflective film of the present invention has a micro convex-concave structure on its surface and contains organic particles uniformly distributed in the resin coating in a single layer, the reflective film of the present invention can reflect light uniformly, minimize the light loss, and effectively enhance the luminance of the backlight module. Therefore, the reflective film of the present invention is useful in a backlight module, particularly, in a direct type backlight module, of a planar display as a brightness enhancement reflective film, to diffuse and homogenize the reflected light, eliminate the phenomenon of bright-and-dark stripes and obtain better brightness uniformity.

The following examples are used to further illustrate the present invention, but not intended to limit the scope of the present invention. Any modifications or alterations that can be easily accomplished by persons skilled in the art fall within the scope of the disclosure of the specification and the appended claims.

### Example 1

### Preparation of UV Curing Resin A

In a 250 mL glass bottle, 40 g toluene was added. Acrylate monomers: 10 g of dipentaerythritol hexaacrylate, 2 g of trimethylolpropane triacrylate and 14 g of pentaerythritol triacrylate, oligomers: 28 g of aliphatic urethane hexaacrylate [Etercure 6145-100, Eternal Company], and a photo initiator: 6 g of 1-hydroxy cyclohexyl phenyl ketone were added sequentially while stirring at a high speed. Finally, UV curable resin A was prepared in an amount of about 100 g and with solid contents of about 60%.

### Preparation of a Reflective Film of the Present Invention

In a 250 mL glass bottle, a solvent of 19.5 g toluene and 9.8 g butanone was added. 32.9 g of acrylic resin particles [SSX-115, Sekisui Plastics Co., Japan: highly-crosslinked organic particles composed of methyl methacrylate and ethylene glycol dimethacrylate monomers in a weight ratio of 50:50 and having a particle size distribution of 15 μm±5%] having a mean particle size of 15 μm, 18.3 g of UV curable resin A, 18.3 g of a thermal setting resin [acrylate resin: Eterac® 7365-S-30, Eternal Company] (with solid contents of about 30%), and 1.0 g of an anti-static agent [GMB-36M-AS, Marubishi Oil Chem. Co., Ltd] (with solid contents of about 20%) were sequentially added while stirring at a high speed; and finally, about 100 g of a coating with solid contents of about 50% was prepared. Then, the coating was coated on a surface of a white PET reflective substrate [UX-188®, Teijin DuPont Company] having a thickness of 188 μm with an RDS Bar Coater #14, dried for 1 minute at 100° C., and exposed to a UV curing machine [Fusion UV, F600V, 600 W/inch, H-type light source]. The power was set on 100%, the speed was 15 m/min, and the energy beam was 200 mJ/cm². After drying, a reflective film of the present invention was prepared and the thickness of the resin coating was about 17 μm.

### COMPARATIVE EXAMPLE 1

A commercially available reflective film [UX-188®, Teijin DuPont Company].

### COMPARATIVE EXAMPLE 2

In a 250 mL glass bottle, a solvent of 19.2 g toluene and 12.8 g butanone was added. 32 g of acrylic resin particles [GR-400T, Negami Chemical Industrial Co., Ltd., Japan, particle size distribution of 15 μm±25%] having a mean particle size of 15 μm, 30.7 g of an acrylate resin [Eterac® 7361-TS-50, Eternal Company] (with solid contents of about 50%), and 1.3 g of a surface-wetting agent [BYK-331, BYK Chemie Company] (with solid contents of about 100%) were sequentially added while stirring at a high speed; and finally, about 100 g of a coating with solid contents of about 50% was prepared. Then, the coating was coated on a surface of a white PET reflective substrate [UX-188®, Teijin DuPont Company] having a thickness of 188 μm with an RDS Bar Coater #14, dried for 1 minute at 100° C., and then a reflective film was prepared and the thickness of the resin coating was about 20 μm.

### Test Method A:

Film Thickness Test: The film thickness of the sample to be tested was measured with a coating thickness gauge (PIM-100, TESA Corporation) under 1 N pressing contact. The results were reported in Table 1 below.

Reflectivity Test: The reflectivity of the samples was measured with an ultraviolet/visible spectrophotometer (Lamda 650, Perkin Elmer Company) at a wavelength ranging from 200 nm to 800 nm, according to ASTM 903-96 method using integrating spheres. The results were reported in Table 1 below.

Gloss 60 Test: The samples were tested with a gloss meter (VG2000, Nippon Denshoku Company) according to ASTM D523 method by projecting light with an incident angle of 60° and measuring the gloss of the surface at a reflective angle of 60°. The results were reported in Table 1 below.

Pencil Hardness Test: The samples were tested with a Pencil Hardness Tester [Elcometer 3086, SCRATCH BOY], using Mitsubishi pencil (2H, 3H), according to JIS K-5400 method. The results were reported in Table 1 below.

Surface Resistivity Test: The surface resistivity of the samples was measured with a Superinsulation Meter [EASTASIA TOADKK Co., SM8220&SME-8310, 500 V]. The conditions of the test were: 23±2° C., 55±5% RH. The results were reported in Table 1.

TABLE 1

| | | Comparative | Comparative |
|---|---|---|---|
| | Example 1 | Example 1 | Example 2 |
| thickness (μm) | 205 | 188 | 208 |
| reflectivity (%) | 96.16 | 97.04 | 96.50 |
| gloss | 3.2 | 68.6 | 3.5 |
| pencil hardness, 3H | OK | Not Good | Not Good |
| surface resistivity | 3.0 × 10¹⁰ | 1.8 × 10¹⁶ | 4.5 × 10¹⁶ |
| (Ω/□) | | | |

According to Table 1, the resin coating of Example 1 has a pencil hardness of 3H and a surface resistivity of 3.0×10¹⁰Ω/□, so that it can prevent the substrate from dust absorption and scratch; whereas the reflective films of Comparative Examples 1 and 2 have worse pencil hardness, worse scratch resistance, and higher surface resistivity. The gloss 60 of the reflective films of Example 1 and Comparative Example 2 is reduced to 3.2 and 3.5, respectively, because the resin coatings contain organic particles to provide a diffusion effect; however, the reflectivity of the films is only slightly lower than that of the commercially available reflective film of Comparative Example 1.

### Testing Method B:

Luminance Measurement Method: The luminance of the samples was tested with a portable luminance meter [K-10, KLEIN company]. The conditions of the test were: 23±2° C., 55±5% RH. The samples were cut into a size of: L×W (42 cm×42 cm) and tested at the following positions: 1. (0.5 L, 0.5 W), 2. (0.1 L, 0.9 W), 3. (0.5 L, 0.9 W), 4. (0.9 L, 0.9 W), 5. (0.1 L, 0.5 W), 6. (0.9 L, 0.5 W), 7. (0.1 L, 0.1 W), 8. (0.5 L, 0.1 W) and 9. (0.9 L, 0.1 W). Central luminance was defined as the luminance at the first position and luminance uniformity was defined as the ratio of the minimum luminance value to the maximum luminance value measured at the above nine positions.

Test 1 Each of the reflective films of Example 1 and Comparative Examples 1 and 2 was assembled in the backlight module used in a 19″ W liquid crystal display [CMV937A, CMO Company] with two lower diffusive films [Etertec® DI-780A, Eternal Company] positioned on the lightguide plate, and then subjected to luminance measurement. The results were reported in Table 2 below.

TABLE 2

| | | | Comparative | Comparative |
|---|---|---|---|---|
| Reflective Film | | Example 1 | Example 1 | Example 2 |
| luminance | 1 | 3253.4 | 2958.0 | 3188.5 |
| at each | 2 | 3471.6 | 3402.1 | 2690.7 |
| position | 3 | 3118.3 | 2858.6 | 2945.6 |
| | 4 | 3174.1 | 2982.3 | 3141.9 |
| | 5 | 3019.5 | 3070.5 | 2572.2 |
| | 6 | 2773.0 | 2663.4 | 2881.7 |
| | 7 | 3278.5 | 3357.3 | 2853.9 |
| | 8 | 3200.1 | 2539.4 | 3325.1 |
| | 9 | 2958.0 | 2832.9 | 3056.7 |

| | | | |
|---|---|---|---|
| central luminance | 3253.4 | 2958.0 | 3188.5 |
| (cd/m²) | | | |
| uniformity (%) | 79.9 | 74.6 | 77.4 |

It can be seen from Table 2 that the module using the reflective film of Example 1 exhibits higher central luminance than the module using the reflective film of Comparative Example 1 or 2. As compared to the reflective films of Comparative Examples 1 or 2, the reflective film of Example 1 increases the uniformity from 74.6% or 77.4% to 79.9%, with an increment of 5.3% or 2.5%.

Test 2 Each of the reflective films of Example 1 and Comparative Examples 1 and 2 was assembled in the backlight module used in a 19″ W liquid crystal display [CMV937A, CMO company] with three lower diffusive films [Etertec® DI-780A, Eternal Company] positioned on the lightguide plate, and then subjected to luminance measurement. The results were reported in Table 3 below.

TABLE 3

| | | | Comparative | Comparative |
|---|---|---|---|---|
| Reflective Film | | Example 1 | Example 1 | Example 2 |
| luminance | 1 | 3438.9 | 3219.4 | 3361.1 |
| at each | 2 | 3654.3 | 3597.5 | 2866.1 |
| position | 3 | 3302.0 | 3099.3 | 3126.8 |
| | 4 | 3339.5 | 3183.9 | 3314.1 |
| | 5 | 3206.4 | 3278.8 | 2751.2 |
| | 6 | 2948.0 | 2862.1 | 3009.4 |
| | 7 | 3428.1 | 3544.3 | 2956.7 |
| | 8 | 3450.4 | 2793.9 | 3474.6 |
| | 9 | 3170.6 | 3074.5 | 3201.8 |

| | | | |
|---|---|---|---|
| central luminance | 3438.9 | 3219.4 | 3361.1 |
| (cd/m²) | | | |
| uniformity (%) | 80.7 | 77.7 | 79.2 |

It can be seen from Table 3 that the module using the reflective film of Example 1 exhibits higher central luminance than the module using the reflective film of Comparative Example 1 or 2. As compared to the reflective films of Comparative Examples 1 or 2, the reflective film of Example 1 increases the uniformity from 77.7% or 79.2% to 80.7%, with an increment of 3.0% or 1.5%.

Test 3 Each of the reflective films of Example 1 and Comparative Examples 1 and 2 was assembled in the backlight module used in a 19″ W liquid crystal display [CMV937A, CMO company] with one lower diffusive film [Etertec® DI-780A, Eternal Company] and one brightness enhancement film [Etertec® PF-962-188, Eternal Company] positioned on the lightguide plate, and then subjected to luminance measurement. The results were reported in Table 4 below.

TABLE 4

| | | | Comparative | Comparative |
|---|---|---|---|---|
| Reflective Film | | Example 1 | Example 1 | Example 2 |
| luminance | 1 | 4416.5 | 4182.5 | 4327.4 |
| at each | 2 | 4713.3 | 4666.3 | 3604.2 |
| position | 3 | 4226.3 | 4057.4 | 4049.3 |
| | 4 | 4308.3 | 4185.5 | 4318.9 |
| | 5 | 4113.3 | 4216.8 | 3447.1 |
| | 6 | 3810.3 | 3709.8 | 3860.1 |
| | 7 | 4434.3 | 4571.3 | 3823.0 |
| | 8 | 4424.3 | 3654.8 | 4492.6 |
| | 9 | 4081.5 | 3995.1 | 4114.1 |

| | | | |
|---|---|---|---|
| central luminance | 4416.5 | 4182.5 | 4327.4 |
| (cd/m²) | | | |
| uniformity (%) | 80.8 | 78.3 | 76.7 |

It can be seen from Table 4 that the module using the reflective film of Example 1 exhibits higher central luminance than the module using the reflective film of Comparative Example 1 or 2. As compared to the reflective films of Comparative Examples 1 or 2, the reflective film of Example 1 increases the uniformity from 78.3% or 76.7% to 80.8%, with an increment of 2.5% or 4.1%.

The results in Tables 1 to 4 show that the reflective film of the present invention has excellent hardness, anti-static properties and luminance. As compared to the reflective film of Comparative Example 2, the organic particles contained in the coating of the reflective film of the present invention have a highly uniform particle size distribution so that the reflective film of the present invention can effectively enhance the luminance of the module and homogenize light.

1. A reflective film, comprising a reflective substrate and a resin coating having a convex-concave structure on a surface of the substrate, wherein said resin coating comprises organic particles and a binder, the particle size distribution of the organic particles ranges within about ±5% ofthe mean particle size of the organic particles, and the organic particles are in an amount from about 180 to about 320 parts by weight per 100 parts by weight of the solid contents of the binder.

2. The reflective film as claimed in claim 1, wherein the reflective substrate is a plastic substrate composed of at least one polymeric resin layer, wherein the polymeric resin is selected from the group consisting of a polyester resin, a polyacrylate resin, a polyimide resin, a polyolefin resin, a polycycloolefin resin, a polycarbonate resin, a polyurethane resin, triacetate cellulose, a polylactic acid and a mixture thereof.

3. The reflective film as claimed in claim 1, wherein the reflective substrate is a monolayer or multilayer structure.

4. The reflective film as claimed in claim 3, wherein one or more layers of said monolayer or multilayer structure contain bubbles and/or fillers.

5. The reflective film as claimed in claim 4, wherein the fillers are organic fillers selected from the group consisting of an acrylic resin, a methacrylic resin, a urethane resin, a silicone resin and a mixture thereof, or inorganic fillers selected from the group consisting of zinc oxide, silica, titanium dioxide, alumina, calcium sulfate, barium sulfate, calcium carbonate and a mixture thereof.

6. The reflective film as claimed in claim 1, wherein the particle size distribution of the organic particles ranges within about ±4% of the mean particle size of the organic particles.

7. The reflective film as claimed in claim 1, wherein the mean particle size of the organic particles ranges from about 5 μm to about 30 μm.

8. The reflective film as claimed in claim 7, wherein the mean particle size of the organic particles ranges from about 10 μm to about 25 μm.

9. The reflective film as claimed in claim 1, wherein the organic particles are in an amount from about 220 to about 305 parts by weight per 100 parts by weight of the solid contents of the binder.

10. The reflective film as claimed in claim 1, wherein the coating thickness of the binder is approximately from two fifths to three fifths of the particle size of the organic particles.

11. The reflective film as claimed in claim 10, wherein the coating thickness of the binder is approximately a half of the particle size of the organic particles.

12. The reflective film as claimed in claim 1, wherein the organic particles are selected from the group consisting of a polyacrylate resin, a polystyrene resin, a polyurethane resin, a polysilicone resin and a mixture thereof.

13. The reflective film as claimed in claim 12, wherein the organic particles are composed of a polyacrylate resin.

14. The reflective film as claimed in claim 13, wherein the polyacrylate resin comprises at least one mono-functional acrylate monomer and at least one multi-functional acrylate monomer as the polymerization units.

15. The reflective film as claimed in claim 14, wherein all the multi-functional acrylate monomers contained in said polyacrylate resin are in an amount from about 30 % to 70 % based on the total weight of the monomers.

16. The reflective film as claimed in claim 14, wherein the mono-functional acrylate monomer is selected from a group consisting of methyl methacrylate, butyl methacrylate, 2-phenoxy ethyl acrylate, ethoxylated 2-phenoxy ethyl acrylate, 2-(2-ethoxyethoxy)ethyl acrylate, cyclic trimethylolpropane formal acrylate, β-carboxyethyl acrylate, lauryl methacrylate, isooctyl acrylate, stearyl methacrylate, isodecyl acrylate, isobornyl methacrylate, benzyl acrylate, 2-hydroxyethyl methacrylate phosphate, hydroxyethyl acrylate, 2-hydroxyethyl methacrylate, and a mixture thereof.

17. The reflective film as claimed in claim 14, wherein the multi-functional acrylate monomer is selected from the group consisting of hydroxypivalyl hydroxypivalate diacrylate, ethoxylated 1,6-hexanediol diacrylate, dipropylene glycol diacrylate, tricyclodecane dimethanol diacrylate, ethoxylated dipropylene glycol diacrylate, neopentyl glycol diacrylate, propoxylated neopentyl glycol diacrylate, ethoxylated bisphenol-A dimethacrylate, 2-methyl-1,3-propanediol diacrylate, ethoxylated 2-methyl-1,3-propanediol diacrylate, 2-butyl-2-ethyl-1,3-propanediol diacrylate, ethylene glycol dimethacrylate, diethylene glycol dimethacrylate, tris(2-hydroxy ethyl)isocyanurate triacrylate, pentaerythritol triacrylate, ethoxylated trimethylolpropane triacrylate, propoxylated trimethylolpropane triacrylate, trimethylolpropane trimethacrylate, pentaerythritol tetraacrylate, ethoxylated pentaerythritol tetraacrylate, ditrimethylolpropane tetraacrylate, propoxylated pentaerythritol tetraacrylate, pentaerythritol tetraacrylate, dipentaerythritol hexaacrylate, tripropylene glycol dimethacrylate, 1,4-butanediol dimethacrylate, 1,6-hexanediol dimethacrylate, allylated cyclohexyl dimethacrylate, isocyanurate dimethacrylate, ethoxylated trimethylol propane trimethacrylate, propoxylated glycerol trimethacrylate, trimethylol propane trimethacrylate, tris(acryloxyethyl)isocyanurate, and a mixture thereof.

18. The reflective film as claimed in claim 14, wherein the polyacrylate resin is formed from the monomers comprising methyl methacrylate and ethylene glycol dimethacrylate.

19. The reflective film as claimed in claim 1, wherein the binder is selected from the group consisting of a ultraviolet (UV) curing resin, a thermal setting resin, a thermal plastic resin, and a mixture thereof.

20. The reflective film as claimed in claim 19, wherein the UV curing resin is formed from at least one acrylic monomer or acrylate monomer having one or more functional groups.

21. The reflective film as claimed in claim 20, wherein the acrylate monomer is selected from the group consisting of a methacrylate monomer, an arcrylate monomer, a urethane acrylate monomer, a polyester acrylate monomer, and an epoxy acrylate monomer.

22. The reflective film as claimed in claim 20, wherein the UV curing resin further comprises an acrylate oligomer.

23. The reflective film as claimed in claim 20, wherein the thermal setting resin is selected from the group consisting of a carboxyl and/or hydroxyl group-containing polyester resin, epoxy resin, polymethacrylate resin, polyacrylate resin, polyamide resin, fluoro resin, polyimide resin, polyurethane resin, alkyd resin, and a mixture thereof.

24. The reflective film as claimed in claim 20, wherein the thermal plastic resin is selected from the group consisting of a polyester resin, a polymethacrylate resin, and a mixture thereof.

25. The reflective film as claimed in claim 1, wherein the resin coating further comprises an additive selected from the group consisting of an anti-static agent, a curing agent, a photo initiator, a fluorescent whitening agent, a UV absorber, a leveling agent, a wetting agent, a stabilizing agent, a dispersing agent, and inorganic particulates.

26. The reflective film as claimed in claim 25, wherein the anti-static agent is selected from the group consisting of ethoxy glycerin fatty acid esters, quaternary amine compounds, aliphatic amine derivatives, polyethylene oxide, siloxane, and alcohol derivatives.

27. The reflective film as claimed in claim 26, wherein the curing agent is a diisocynate or polyisocyanate.

28. The reflective film as claimed in claim 1, wherein the organic particles are uniformly distributed in the resin coating in a single layer.
